(19) United States
(12) Patent Application Publication
(10) Pub. No.: US 2026/0098494 A1
(43) Pub. Date: Apr. 9, 2026

(54) Exhaust System, Internal Combustion Engine, and Vehicle

(71) Applicant: Scania CV AB, Södertälje (SE)

(72) Inventors: Magnus Lindgren, Älvsjö (SE); Per-Erik Nilsson, Nykvarn (SE); Oskar Leufven, Södertälje (SE); Carl Fredriksson, Kinna (SE)

(21) Appl. No.: 19/114,255

(22) PCT Filed: Sep. 20, 2023
(86) PCT No.: PCT/SE2023/050923

§ 371 Date: Mar. 21, 2025

(30) Foreign Application Priority Data
Sep. 22, 2022 (SE) 2251096-0

(51) Int. Cl. F02B 37/18; F02B 37/22

(52) U.S. Cl. CPC F02B 37/18; F01N 3/2066; F01N 13/08; F02B 37/025; F02B 37/22; F02C 6/12; F01N 2560/026

(57) ABSTRACT

An exhaust system for an internal combustion engine is disclosed. The exhaust system comprises a turbine arrangement for a turbo device. The turbine arrangement comprising a turbine housing and a turbine unit arranged to rotate in the turbine housing. The exhaust system further comprises a bypass channel with an inlet opening arranged upstream of a turbine outlet of the turbine unit and an outlet opening arranged downstream of the turbine outlet. The exhaust system further comprises a NOx sensor arranged to sense a NOx content of exhaust gas flowing through the bypass channel. The present disclosure further relates to an internal combustion engine and a vehicle.

### TECHNICAL FIELD

The present disclosure relates to an exhaust system for an internal combustion engine, wherein the exhaust system comprises a turbine arrangement for a turbo device. The present disclosure further relates to an internal combustion engine comprising an exhaust system and a vehicle comprising an internal combustion engine.

### BACKGROUND

Turbo devices are used on internal combustion engines to increase the performance and/or the fuel efficiency of the engine. One type of turbo device is a turbocharger. A turbocharger comprises a turbine unit and a compressor, wherein the turbine unit is driven by exhaust gas in an exhaust system of the engine to power the compressor. The compressor forces air to an air inlet of the engine which allows more fuel to be added and hence higher power output of the engine. A turbocharger is an efficient means of supercharging an engine since it utilizes energy of the exhaust gasses of the engine to compress the inlet air of the engine.

Another type of turbo device is a turbo compound. A turbo compound also comprises a turbine unit driven by exhaust gas of the engine. However, instead of powering a compressor, the energy recovered from the exhaust gasses is sent to an output shaft of the engine or is used for another purpose, such as powering an electric generator, or the like. The produced electricity can be used to produce motive power to the vehicle in an electric machine or can be used to power one or more other subsystems of the vehicle. A turbo compound is an efficient means of increasing the total fuel efficiency since it is capable of converting part of the energy of the exhaust gases into useful energy.

Since the turbine unit of a turbo device is configured to extract energy of the exhaust gasses of the engine, the temperature and the pressure of the exhaust gas is, in most cases, higher upstream of the turbine unit than downstream of the turbine unit.

Environmental concerns, as well as emissions standards for motor vehicles, have led to the development of combustion engine assemblies using exhaust additives, such as reducing agents for diesel, and/or ethanol, exhaust gases. Reducing agents may comprise an aqueous urea solution and may be used as a consumable in a Selective Catalytic Reduction SCR catalyst in order to lower nitrogen oxides NOx concentration in exhaust emissions from the internal combustion engine.

Nitrogen oxides NOx are formed by a reaction between oxygen O2 and nitrogen N upon high temperatures and pressures in a cylinder of an engine. In other words, when the operation of the engine is optimized regarding fuel efficiency, large amounts of nitrogen oxides NOx may be formed. The term NOx represents several forms of nitrogen oxides including nitric oxide NO and nitrogen dioxide NO2.

A selective catalytic reduction arrangement is a means of converting nitrogen oxides NOx with the aid of a catalyst into diatomic nitrogen N2, and water H2O using a reduction agent added to a stream of exhaust gas which is adsorbed onto a catalyst substrate of the SCR catalyst. The reduction agent may comprise a gaseous reductant, typically anhydrous ammonia, aqueous ammonia, or urea. Some exhaust systems have been developed comprising two or more SCR catalysts arranged in series.

In internal combustion engines comprising a turbo device and one or more SCR catalysts, the SCR catalyst/catalysts is/are usually arranged downstream of the turbine unit of the turbo device. In this manner, the SCR catalyst/catalysts has/have a low impact on the flow of exhaust gas from exhaust valves of the combustion engine to the turbine unit.

The use of exhaust additives is associated with some problems and design difficulties. One problem is the requirement for an efficient mixing in order to achieve uniform distribution of exhaust additive over the entire surface area of a catalyst substrate. The space available for mixing is limited which may cause an insufficient mixing of the exhaust additive and the exhaust gas upstream of the catalyst substrate. An insufficient mixing between the exhaust additive and the exhaust gas reduces the reduction efficiency at the catalyst substrate and may cause formation of deposits of the exhaust additive inside the exhaust system.

Modern engines usually comprise various sensors arranged to sense a property of the exhaust gas of the engine, such as one or more NOx sensors, one or more oxygen sensors, and one or more temperature sensors. A nitrogen oxide sensor, also referred to as a NOx sensor, is a device which can be used to detect nitrogen oxides in a stream of exhaust gas from an internal combustion engine.

A NOx sensor can be arranged downstream of a SCR catalyst to measure the NOx content in the exhaust gas downstream of the SCR catalyst. In this manner, the NOx conversion rate of the SCR catalyst can be monitored. Moreover, a NOx sensor can be arranged upstream of the first SCR catalyst of an exhaust system. In this manner, the NOx generation of the internal combustion engine can be monitored.

The placement of various types of sensors in an exhaust system of an internal combustion engine is a problem. For example, sensors, such as NOx sensors, are sensitive components which may become damaged if subjected to too high temperatures and pressures. Moreover, some types of sensors, such as NOx sensors, are not able to provide reliable data at too high pressures and/or temperatures.

Moreover, the injection of exhaust additive into a stream of exhaust gas may cause disturbances of the measurements obtained by a sensor and the sensor can provide erroneous data if mounted to close to an exhaust additive injection point in the exhaust system. As an example, a NOx sensor can register ammonia of an exhaust additive as NOx. Moreover, as indicated above, the space available inside an exhaust system is limited and it may be difficult to position an exhaust additive dosing unit to obtain a sufficient mixing between the exhaust additive and the exhaust gas before the mixture reaches the catalytic substrate.

### SUMMARY

It is an object of the present invention to overcome, or at least alleviate, at least some of the above-mentioned problems and drawbacks.

According to a first aspect of the invention, the object is achieved by an exhaust system for an internal combustion engine, wherein the exhaust system comprises a turbine arrangement for a turbo device. The turbine arrangement comprises a turbine housing and a turbine unit arranged to rotate in the turbine housing. The exhaust system further comprises a bypass channel with an inlet opening arranged upstream of a turbine outlet of the turbine unit and an outlet opening arranged downstream of the turbine outlet. The exhaust system further comprises a NOx sensor configured to sense a NOx content of exhaust gas flowing through the bypass channel.

Thereby, conditions are provided for obtaining reliable data of the NOx content of the exhaust gas flowing through the bypass channel, while avoiding damages to the NOx sensor caused by excessive temperatures and/or pressures. Since the bypass channel comprises the inlet opening arranged upstream of the turbine outlet and the outlet opening arranged downstream of the turbine outlet, a continuous flow of exhaust gas can be obtained through the bypass channel during operation of the exhaust system.

Moreover, the NOx content of the exhaust gas flowing through the bypass channel is representative of a NOx content of exhaust gas flowing through the turbine outlet because the bypass channel is configured to receive exhaust gas from the inlet opening arranged upstream of the turbine outlet. In this manner, conditions are provided for obtaining reliable data of the NOx content of the exhaust gas flowing through the turbine unit of the turbine arrangement, while avoiding damages to the NOx sensor caused by excessive temperatures and/or pressures.

Furthermore, since the bypass channel comprises the inlet opening arranged upstream of the turbine outlet and the outlet opening arranged downstream of the turbine outlet, conditions are provided for injecting an exhaust additive to the exhaust gas at a position close to the turbine unit of the turbine arrangement without disturbing the measurements obtained by the NOx sensor. This is because the bypass channel is configured to receive exhaust gas from the inlet opening arranged upstream of the turbine outlet of the turbine unit.

Accordingly, due to these features, an exhaust system is provided having conditions for providing reliable data of the NOx content of the exhaust gas flowing through the turbine unit of the turbine arrangement, while being robust and having conditions for adding exhaust additive to the exhaust gas at a position close to the turbine unit to obtain a high degree of mixing between the exhaust additive and the exhaust gas without disturbing the measurements obtained by the NOx sensor.

Accordingly, an exhaust system is provided overcoming, or at least alleviating, at least some of the above-mentioned problems and drawbacks. As a result, the above-mentioned object is achieved.

As understood from the above, the bypass channel is fluidly connected to the exhaust system at a position upstream of the turbine outlet of the turbine unit and is fluidly connected to the exhaust system at a position downstream of the turbine outlet via the second opening. The bypass channel is referred to as a “bypass” channel because the bypass channel bypasses at least the turbine outlet of the turbine unit. A continuous flow of exhaust gas through the bypass channel from the inlet opening towards the outlet opening can be ensured because the pressure in the exhaust system is, in almost all operational conditions, higher upstream of the turbine outlet than downstream of the turbine outlet. This is because the turbine of a turbine arrangement is configured to extract energy from the stream of exhaust gas therethrough.

Optionally, the inlet opening of the bypass channel is arranged on the turbine housing. Thereby, it can be ensured that exhaust gases from different cylinders of the combustion engine are mixed before flowing into the bypass channel via the inlet opening. In this manner, conditions are provided for obtaining even more reliable data of the NOx content of the exhaust gas flowing through the turbine unit of the turbine arrangement. Moreover, a space efficient solution is provided requiring only a short routing of the bypass channel. Furthermore, damages to the NOx sensor caused by excessive temperatures and/or pressures can be further avoided due to lower temperatures and pressures of the exhaust gas in the turbine housing as compared to exhaust gas in portions of the exhaust system further upstream.

Optionally, the turbine housing comprises a turbine inlet, and wherein the inlet opening of the bypass channel is arranged on the turbine inlet of the turbine housing. Thereby, it can be ensured that exhaust gases from different cylinders of the combustion engine are mixed before flowing into the bypass channel via the inlet opening. In this manner, conditions are provided for obtaining even more reliable data of the NOx content of the exhaust gas flowing through the turbine unit of the turbine arrangement. Moreover, a space efficient solution is provided requiring only a short routing of the bypass channel. Furthermore, damages to the NOx sensor caused by excessive temperatures and/or pressures can be further avoided due to lower temperatures and pressures of the exhaust gas in the turbine inlet of the turbine housing as compared to exhaust gas in portions of the exhaust system further upstream.

Optionally, the turbine inlet comprises a turbine inlet scroll, and wherein the inlet opening of the bypass channel is arranged on the turbine inlet scroll. Thereby, it can be ensured that exhaust gases from different cylinders of the combustion engine are mixed before flowing into the bypass channel via the inlet opening. In this manner, conditions are provided for obtaining even more reliable data of the NOx content of the exhaust gas flowing through the turbine unit of the turbine arrangement. Moreover, a space efficient solution is provided requiring only a short routing of the bypass channel. Furthermore, damages to the NOx sensor caused by excessive temperatures and/or pressures can be further avoided due to lower temperatures and pressures of the exhaust gas in the turbine inlet scroll as compared to exhaust gas in portions of the exhaust system further upstream.

Optionally, the turbine inlet comprises two turbine inlet scrolls, and wherein the bypass channel comprises two inlet openings each arranged on one of the two turbine inlet scrolls. Since the turbine inlet comprises two turbine inlet scrolls, the pulsating flow of exhaust gas obtained from the total number of cylinders of the combustion engine can be utilized in a more efficient manner to increase the efficiency of the turbine arrangement. Moreover, since the bypass channel comprises two inlet openings each arranged on one of the two turbine inlet scrolls, it can be ensured that exhaust gases from different cylinders of the combustion engine are mixed before reaching the NOx sensor. In this manner, conditions are provided for obtaining even more reliable data of the NOx content of the exhaust gas flowing through the turbine unit of the turbine arrangement. Moreover, a space efficient solution is provided requiring only a short routing of the bypass channel. Furthermore, damages to the NOx sensor caused by excessive temperatures and/or pressures can be further avoided due to lower temperatures and pressures of the exhaust gas in the turbine inlet scrolls as compared to exhaust gas in portions of the exhaust system further upstream.

Optionally, the turbine housing comprises a turbine shroud enclosing at least a portion of the turbine unit, and wherein the inlet opening of the bypass channel is arranged on the turbine shroud. Thereby, it can be ensured that exhaust gases from different cylinders of the combustion engine are mixed before flowing into the bypass channel via the inlet opening. In this manner, conditions are provided for obtaining even more reliable data of the NOx content of the exhaust gas flowing through the turbine unit of the turbine arrangement. Moreover, a space efficient solution is provided requiring only a short routing of the bypass channel. Furthermore, damages to the NOx sensor caused by excessive temperatures and/or pressures can be further avoided due to lower temperatures and pressures of the exhaust gas in the turbine shroud as compared to exhaust gas in portions of the exhaust system further upstream.

Optionally, the turbine arrangement comprises a turbine outlet duct configured to receive exhaust gas from the turbine outlet at a first side of the turbine unit, wherein the turbine housing comprises a compartment at a second side of the turbine unit being opposite to the first side, and wherein the inlet opening of the bypass channel is fluidly connected to the compartment. Thereby, it can be ensured that exhaust gases from different cylinders of the combustion engine are mixed before flowing into the bypass channel via the inlet opening. In this manner, conditions are provided for obtaining even more reliable data of the NOx content of the exhaust gas flowing through the turbine unit of the turbine arrangement. Moreover, a space efficient solution is provided requiring only a short routing of the bypass channel. Furthermore, damages to the NOx sensor caused by excessive temperatures and/or pressures can be further avoided due to lower temperatures and pressures of the compartment at the second side of the turbine as compared to exhaust gas in portions of the exhaust system further upstream.

Optionally, the inlet opening of the bypass channel is provided in a delimiting wall of the compartment. Thereby, the inlet opening can be provided in a simple and cost-effective manner.

Optionally, the bypass channel comprises a flow restriction portion having a smaller effective cross-sectional area than other portions of the bypass channel, and wherein the flow restriction portion is arranged in the bypass channel at a position upstream of the NOx sensor. Thereby, damages to the NOx sensor caused by excessive temperatures and/or pressures is further avoided in an efficient manner. Moreover, it can be ensured that the NOx sensor can provide reliable data over the full operational range of the internal combustion engine comprising the exhaust system.

Optionally, the turbine housing comprises a turbine outlet duct configured to receive exhaust gas from the turbine outlet, and wherein the turbine arrangement comprises an exhaust additive dosing unit arranged to supply an exhaust additive inside the turbine outlet duct. Since the turbine arrangement comprises the NOx sensor arranged to sense a NOx content of exhaust gas flowing through the bypass channel, conditions are provided for arranging the exhaust additive dosing unit to supply the exhaust additive at a position close to the turbine unit of the turbine arrangement without disturbing the measurements obtained by the NOx sensor. In this manner, a high degree of mixing between the exhaust additive and the exhaust gas can be ensured upstream of an SCR catalyst without disturbing the measurements obtained by the NOx sensor.

Optionally, the turbine arrangement comprises a distribution device arranged on the turbine unit, and wherein the exhaust additive dosing unit is arranged to supply an exhaust additive onto the distribution device. Thereby, conditions are provided for a high degree of mixing between the exhaust additive and the exhaust gas upstream of an SCR catalyst while having conditions for obtaining reliable data from the NOx sensor.

Optionally, the outlet opening of the bypass channel is arranged on the turbine housing. Thereby, a space efficient solution is provided requiring only a short routing of the bypass channel.

Optionally, the turbine housing comprises a waste gate chamber configured to receive exhaust gas from a waste gate valve, and wherein the outlet opening is provided in a delimiting wall of the waste gate chamber. Thereby, a space efficient solution is provided utilizing an already existing chamber for accommodating the outlet opening. Moreover, conditions are provided for a short routing of the bypass channel.

Optionally, the exhaust system comprises an exhaust throttle controllable to a closed state in which the exhaust throttle at least partially blocks flow of exhaust gas past the exhaust throttle, and wherein the outlet opening of the bypass channel is arranged downstream of the exhaust throttle. Since the exhaust system comprises the exhaust throttle, an efficient engine braking can be performed of a combustion engine comprising the exhaust system. Moreover, since the outlet opening of the bypass channel is arranged downstream of the exhaust throttle, the NOx sensor is protected from becoming damaged by excessive pressures when the exhaust throttle is controlled to the closed state.

According to a second aspect of the invention, the object is achieved by an internal combustion engine comprising an exhaust system according some embodiments of the present disclosure. Since the internal combustion engine comprises an exhaust system according to some embodiments, an internal combustion engine is provided overcoming, or at least alleviating, at least some of the above-mentioned problems and drawbacks. As a result, the above-mentioned object is achieved.

According to a third aspect of the invention, the object is achieved by a vehicle comprising an internal combustion engine according some embodiments of the present disclosure. Since the vehicle comprises an internal combustion engine according to some embodiments, a vehicle is provided overcoming, or at least alleviating, at least some of the above-mentioned problems and drawbacks. As a result, the above-mentioned object is achieved.

Further features of, and advantages with, the present invention will become apparent when studying the appended claims and the following detailed description.

### BRIEF DESCRIPTION OF THE DRAWINGS

Various aspects of the invention, including its particular features and advantages, will be readily understood from the example embodiments discussed in the following detailed description and the accompanying drawings, in which:

FIG. 1 schematically illustrates a vehicle according to some embodiments of the present disclosure,

FIG. 2 schematically illustrates an internal combustion engine of the vehicle illustrated in FIG. 1,

FIG. 3 illustrates a cross section of a turbine arrangement of an exhaust system of the internal combustion engine illustrated in FIG. 2,

FIG. 4 illustrates a cross section of a turbine arrangement according to some further embodiments,

FIG. 5 illustrates a cross section of a turbine arrangement according to some further embodiments, and

FIG. 6 illustrates an exhaust system according to some further embodiments.

### DETAILED DESCRIPTION

Aspects of the present invention will now be described more fully. Like numbers refer to like elements throughout. Well-known functions or constructions will not necessarily be described in detail for brevity and/or clarity.

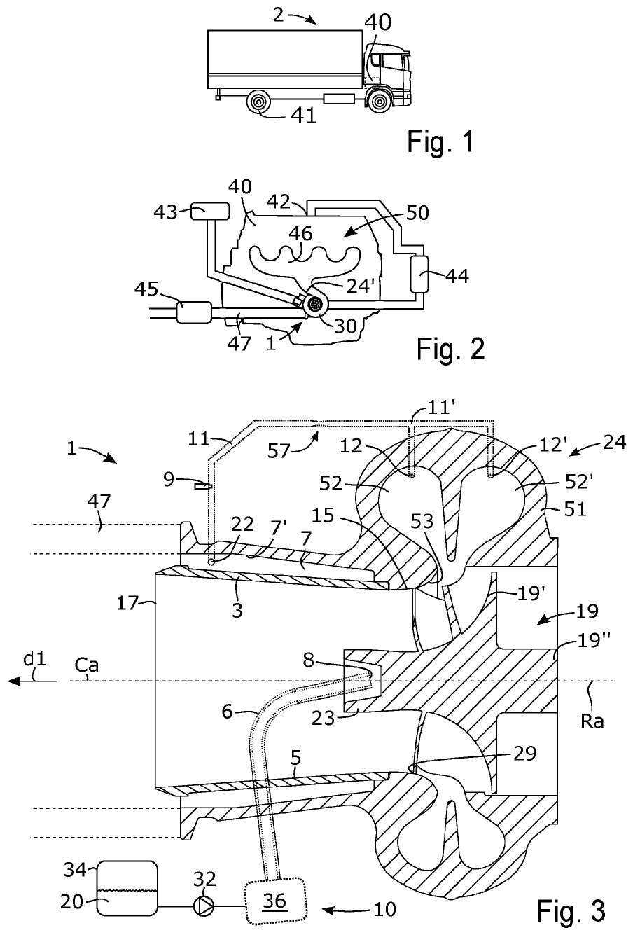

FIG. 1 schematically illustrates a vehicle 2 according to some embodiments of the present disclosure. According to the illustrated embodiments, the vehicle 2 is a truck, i.e., a heavy vehicle. However, according to further embodiments, the vehicle 2, as referred to herein, may be another type of manned or unmanned vehicle for land or water-based propulsion such as a lorry, a bus, a construction vehicle, a tractor, a car, a ship, a boat, or the like.

The vehicle 2 comprises an internal combustion engine 40. According to the illustrated embodiments, the internal combustion engine 40 is configured to provide motive power to the vehicle 2 via wheels 41 of the vehicle 2.

FIG. 2 schematically illustrates the internal combustion engine 40 of the vehicle 2 illustrated in FIG. 1. The internal combustion engine 40 is in some places herein referred to as the “combustion engine 40”, or simply “the engine 40”, for reasons of brevity and clarity. Below, simultaneous reference is made to FIG. 1 and FIG. 2, if not indicated otherwise.

The vehicle 2 may comprise one or more electric propulsion motors in addition to the internal combustion engine 40 for providing motive power to the vehicle 2. Thus, the vehicle 2, as referred to herein, may comprise a so-called hybrid electric powertrain comprising one or more electric propulsion motors in addition to the combustion engine 40 for providing motive power to the vehicle 2.

According to embodiments herein, the internal combustion engine 40 is a four-stroke internal combustion engine. Moreover, according to the illustrated embodiments, the internal combustion engine 40 is a diesel engine, i.e., a type of compression ignition engine. The internal combustion engine 40 may thus be a compression ignition engine configured to operate on diesel or a diesel-like fuel, such as biodiesel, biomass to liquid (BTL), or gas to liquid (GTL) diesel. Diesel-like fuels, such as biodiesel, can be obtained from renewable sources such as vegetable oil which mainly comprises fatty acid methyl esters (FAME). Diesel-like fuels can be produced from many types of oils, such as rapeseed oil (rapeseed methyl ester, RME) and soybean oil (soy methyl ester, SME).

According to further embodiments, the internal combustion engine 40, as referred to herein, may be an Otto engine with a spark-ignition device, wherein the Otto engine may be configured to run on petrol, alcohol, similar volatile fuels, or combinations thereof. Alcohol, such as ethanol, can be derived from renewable biomass. According to some embodiments, the internal combustion engine 40, as referred to herein, may be arranged to power another type of device, system, or unit than a vehicle, such as for example an electric generator, a ship, a boat, or the like.

The combustion engine 40 comprises an exhaust system 50. The exhaust system 50 is configured to conduct exhaust gas from exhaust valves of the combustion engine 40 to the surroundings. The exhaust system 50 comprises a turbo device 30 comprising a turbine arrangement 1. As is further explained herein, the turbine arrangement 1 of the turbo device 30 comprises a turbine unit configured to be driven by exhaust gas of the internal combustion engine 40.

According to the illustrated embodiments, the turbo device 30 is a turbocharger, i.e., a charging device configured to compress air to an air inlet 42 of the combustion engine 40. Thus, according to these embodiments, the turbine unit of the turbo device 30 is connected to the compressor. According to further embodiments, the turbo device 30, as referred to herein, may be a turbo compound device wherein the turbine unit is connected to an output shaft of the combustion engine 40 or to another shaft or type of device configured to produce useful energy by the rotation of the turbine unit.

According to the illustrated embodiments, the combustion engine 40 comprises an air filter unit 43 and a charge air cooler 44. The compressor of the turbo device 30 is configured to force air from the air filter unit 43 to the air inlet 42 of the combustion engine 40. The charge air cooler 44 is arranged between the compressor of the turbo device 30 and the air inlet 42 of the combustion engine 40. The charge air cooler 44 is configured to cool the compressed air before the air is conducted to the air inlet 42. In this manner, the power output and fuel efficiency of the combustion engine 40 can be improved.

Moreover, according to the illustrated embodiments, the exhaust system 50 comprises a Selective Catalytic Reduction SCR catalyst 45 arranged downstream of the turbine unit of the turbine arrangement 1. Furthermore, the exhaust system 50 comprises an exhaust conduit 47 fluidly connecting the Selective Catalytic Reduction SCR catalyst 45 to the turbine arrangement 1 of the turbo device 30. According to further embodiments, the exhaust system 50 may comprise another type of catalytic converter than a Selective Catalytic Reduction SCR catalyst 45.

FIG. 3 illustrates a cross section of the turbine arrangement 1 of the exhaust system 50 of the combustion engine 40 illustrated in FIG. 2. The turbine arrangement 1 comprises a turbine housing 51 and a turbine unit 19 arranged to rotate in the turbine housing 51. The turbine arrangement 1 may also be referred to as a turbine assembly for a turbo device. The turbine unit 19 is configured to be driven by exhaust gas of an internal combustion engine, such as the combustion engine 40 illustrated in FIG. 2. The turbine arrangement 1 may form part of turbo device in the form of a turbocharger or a turbo device in the form of a turbo compound device. As understood from the above, the turbo device 30 illustrated in FIG. 2 may comprise a turbine arrangement 1 according to the embodiments illustrated in FIG. 3. Therefore, below, simultaneous reference is made to FIG. 2 and FIG. 3 if not indicated otherwise.

The turbine unit 19 is configured to rotate around a rotation axis Ra during operation of a turbo device 30 comprising the turbine arrangement 1. In FIG. 3, the cross section is made in a plane comprising the rotation axis Ra of the turbine unit 19. The turbine unit 19 comprises a turbine 19′ and a shaft 19″ connected to the turbine 19′. The turbine 19′, as referred to herein, may also be referred to as a turbine wheel. According to the illustrated embodiments, the turbine 19′ and the shaft 19″ are formed by one piece of coherent material. According to further embodiments, the turbine 19′ and the shaft 19″ may be separate parts wherein the turbine 19′ is connected to the shaft 19′.

In embodiments in which the turbine arrangement 1 forms part of a turbo device 30 in the form of a turbocharger, the shaft 19″ of the turbine unit 19 is connected to a compressor, such as a compressor explained with reference to FIG. 2. In embodiments in which the turbine arrangement 1 forms part of a turbo device 30 in the form of a turbo compound device, the shaft 19″ of the turbine unit 19 may be connected to an output shaft of a combustion engine 40 or to another shaft or type of device configured to produce useful energy by the rotation of the turbine unit 19.

The turbine housing 51 comprises a turbine inlet scroll 52, 52′. The turbine inlet scroll 52, 52′ may also be referred to as a turbine volute. The turbine inlet scroll 52, 52′ may be fluidly connected to a number of exhaust valves of a combustion engine via an exhaust manifold, such as the exhaust manifold 46 of the combustion engine 40 illustrated in FIG. 2. In more detail, according to the illustrated embodiments, the turbine housing 51 comprises two turbine inlet scrolls 52, 52′. The turbine arrangement 1 may therefore also be referred to as a twin scroll turbine arrangement.

Each of the two turbine inlet scrolls 52, 52′ may be fluidly connected to exhaust valves of a number of cylinders of the combustion engine 40 via a separate exhaust manifold. In other words, a first inlet scroll 52 of the two turbine inlet scrolls 52, 52′ may be fluidly connected to exhaust valves of a first set of cylinders of the combustion engine 40 via a first exhaust manifold, wherein a second inlet scroll 52′ of the two turbine inlet scrolls 52, 52′ is fluidly connected to exhaust valves of a second set of cylinders of the combustion engine 40 via a second exhaust manifold, and wherein the second set of cylinders is different from the first set of cylinders. In this manner, the pulsating flow of exhaust gas obtained from the total number of cylinders of the combustion engine 40 can be utilized in a more efficient manner to increase the efficiency of the turbine arrangement 1.

As defined herein, the turbine housing 51 comprises a turbine inlet 24 which comprises the two turbine inlet scrolls 52, 52′ and a portion 24′ of the turbine housing 51 upstream of the two turbine inlet scrolls 52, 52′. However, the turbine inlet 24, as referred to herein may also comprise one turbine inlet scroll and a portion 24′ of the turbine housing 51 upstream of the turbine inlet scroll. The portion 24′ of the turbine housing 51 upstream of the two turbine inlet scrolls 52, 52′ is indicated in FIG. 2. The turbine housing 51 is connected to the exhaust manifold 46 of the combustion engine 40 via the portion 24′ of the turbine housing 51 as is indicated in FIG. 2. The exhaust manifold 46 fluidly connects turbine housing 51 to a number of cylinders of the combustion engine 40.

The turbine housing 51 further comprises a turbine shroud 53 and a turbine outlet duct 3. The turbine shroud 53 encloses at least a portion of the turbine 19′ of the turbine unit 19. The turbine outlet duct 3 is arranged downstream of the turbine 19′ of the turbine unit 19 and is configured to receive exhaust gas from the turbine 19′ of the turbine unit 19. In more detail, the turbine unit 19 comprises a turbine outlet 29 facing the turbine outlet duct 3, wherein the turbine outlet duct 3 is configured to receive exhaust gas from the turbine outlet 29. As defined herein, the turbine outlet 29 is positioned at an interface between the turbine shroud 53 and the turbine outlet duct 3.

Moreover, the turbine outlet duct 3 comprises a first and a second end portion 15, 17, wherein the first end portion 15 is arranged at the interface between the turbine shroud 53 and the turbine outlet duct 3. According to the illustrated embodiments, the turbine outlet duct 3 has a frustoconical inner surface formed by a wall 5 thereof. According to further embodiments, the inner surface of the turbine outlet duct 3 may have another shape than frustoconical. The effective cross-sectional area of the turbine outlet duct 3, measured in a plane perpendicular to a centre axis Ca of the turbine outlet duct 3, increases along an intended flow direction d1 through the turbine outlet duct 3. The intended flow direction d1 through the turbine outlet duct 3 coincides with a direction pointing from the first end portion 15 of the turbine outlet duct 3 towards the second end portion 17 of the turbine outlet duct 3.

Thus, according to the illustrated embodiments, the turbine outlet duct 3 functions as a diffuser which reduces the flow velocity and increases the static pressure along the intended flow direction d1 inside the turbine outlet duct 3. Therefore, the turbine outlet duct 3, as referred to herein, may also be referred to as a diffuser pipe, a diffuser, or the like.

During operation of the turbine arrangement 1, the exhaust gas is flowing from cylinders of the combustion engine 40 through the exhaust manifold 46 into the turbine housing 51 via the portion 24′ thereof and into the turbine 19′ of the turbine unit 19 via the two turbine inlet scrolls 52, 52′, through the turbine shroud 53, and into the turbine outlet duct 3 via the turbine outlet 29. As mentioned, the exhaust system 50 comprises the exhaust conduit 47 connected to the turbine outlet duct 3. The exhaust conduit 47 is indicated in FIG. 2 and FIG. 3. As understood from the above, the flow of exhaust gas through the turbine 19′ causes rotation of the turbine unit 19 around the rotation axis Ra.

According to the illustrated embodiments, the turbine outlet duct 3 forms part of the turbine housing 51 but may also be a separate part attached to the turbine housing 51. However, since the turbine outlet duct 3 forms part of the turbine housing 51 according to the illustrated embodiments, the turbine outlet duct 3, as referred to herein, may also be referred to as a turbine housing or a portion of a turbine housing downstream of a turbine outlet 29 of a turbine unit 19 of the turbine arrangement 1.

Moreover, as understood from the above, the turbine shroud 53 and the turbine outlet duct 3 may collectively be referred to as an exhaust conducting section 31 of the turbine arrangement 1. According to the illustrated embodiments, the turbine shroud 53 and the turbine outlet duct 3 are formed by one piece of coherent material. According to further embodiments, the turbine shroud 53 and the turbine outlet duct 3 may each be formed by separate piece of material and may be assembled to each other to form the exhaust conducting section 31.

According to embodiments herein, the exhaust system 50 comprises a bypass channel 11 with an inlet opening 12, 12′ arranged upstream of the turbine outlet 29 of the turbine unit 19 and an outlet opening 22 arranged downstream of the turbine outlet 29. Moreover, the exhaust system 50 comprises a NOx sensor 9 arranged to sense a NOx content of exhaust gas flowing through the bypass channel 11.

Thereby, conditions are provided for obtaining reliable data of the NOx content of the exhaust gas flowing through the turbine unit 19 of the turbine arrangement 1, while avoiding damages to the NOx sensor 9 caused by excessive temperatures and/or pressures. Moreover, due to these features, conditions are provided for injecting an exhaust additive 20 to the exhaust gas inside the exhaust system 50 at a position close to the turbine unit 19′ of the turbine arrangement 1 without disturbing the measurements obtained by the NOx sensor 9, as is further explained herein.

According to further embodiments, the exhaust system 50 may in addition to the NOx sensor 9 comprise another type of sensor configured to sense another type of property than a NOx content of the gas flowing through the bypass channel 11, such as a temperature sensor configured to sense the temperature of the gas flowing through the bypass channel 11 or an oxygen sensor configured to sense an oxygen content of the gas flowing through the bypass channel 11.

The turbine arrangement 1 according to the illustrated embodiments comprises an exhaust additive dosing unit 6 arranged to supply an exhaust additive 20 inside the turbine outlet duct 3. In these embodiments, the exhaust additive dosing unit 6 is arranged to supply the exhaust additive 20 at a position closer to the first end portion 15 than to the second end portion 17.

In more detail, according to the illustrated embodiments, the turbine arrangement 1 comprises an exhaust additive dosing arrangement 10 comprising the exhaust additive dosing unit 6. The exhaust additive dosing arrangement 10 comprises an exhaust additive storage unit 34 configured to accommodate exhaust additive 20, such as an aqueous urea solution, and a pump 32 configured to pump exhaust additive 20 from the exhaust additive storage unit 34 to the exhaust additive dosing unit 6.

The exhaust additive dosing unit 6 is formed as a supply tube which protrudes into the turbine outlet duct 3. The exhaust additive dosing unit 6 comprises an opening 8 for the supply of the exhaust additive 20 to the stream of exhaust gas inside the turbine outlet duct 3. According to the illustrated embodiments, the exhaust additive dosing unit 6 is arranged such that a centre axis Ca of the turbine outlet duct 3 extends through the opening 8 of the exhaust additive dosing unit 6.

Moreover, the exhaust additive dosing arrangement 10 may comprise some further components 36 between the pump 32 and the exhaust additive dosing unit 6. In FIG. 3, such further components 36 are indicated with the reference sign 36 and may comprise further tubing, a dosing valve, and the like.

The exhaust additive dosing arrangement 10 according to the illustrated embodiments is an airless exhaust additive dosing arrangement 10 meaning that the exhaust additive 20 is supplied to exhaust gas without the use of pressurized air as is the case in some other types of exhaust additive dosing arrangements. However, according to further embodiments, the exhaust additive dosing arrangement 10 of the turbine arrangement 1 may utilize pressurized air for supplying exhaust additive to the stream of exhaust gas inside the turbine outlet duct 3.

According to the illustrated embodiments, the turbine arrangement 1 comprises a distribution device 23 arranged on the turbine unit 19, and wherein the exhaust additive dosing unit 6 is arranged to supply an exhaust additive 20 onto the distribution device 23. The distribution device 23 is arranged at a centre of the turbine unit 19 meaning that the rotational axis Ra of the turbine unit 19 extends through the distribution device 23.

As is apparent from FIG. 3, according to the illustrated embodiments, the rotational axis Ra of the turbine unit 19 coincides with the centre axis Ca of the turbine outlet duct 3. According to the illustrated embodiments, the distribution device 23 form part of the turbine 19′ of the turbine unit 19, i.e., the distribution device 23 and the turbine 19′ are formed by one piece of coherent material. According to further embodiments, the distribution device 23 may be a separate part attached to the turbine unit 19 for example by welding and/or by one or more fastening elements.

According to the illustrated embodiments, the distribution device 23 is cup-shaped and the exhaust additive dosing unit 6 protrudes into an open face of the cup-shaped distribution device 23 such that the opening 8 of the exhaust additive dosing unit 6 is positioned inside the cup-shaped distribution device 23. Since the distribution device 23 corotates with the turbine unit 19 at high rotational speeds, an efficient distribution and atomisation of exhaust additive 20 is provided. In addition, the cup-shape of the distribution device 23 prevents back-flow from a rim of the cup-shaped distribution device 23 and reduces the risk of exhaust additive 20 being unintentionally deposited on surfaces of the turbine 19′.

According to further embodiments, the distribution device 23 may have another shape. As an example, according to some embodiments, the distribution device 23 may comprise a receiving surface forming a patterned facial surface. This patterned surface may be used to control and optimise the distribution of exhaust additive in the exhaust stream. As an alternative, or in addition, the exhaust additive distribution device 23 may comprise a radial wall, wherein the receiving surface exhaust additive distribution device 23 is an inner face of the radial wall, wherein the exhaust additive distribution device 23 comprises a distribution surface of an orifice formed in the radial wall, and wherein the orifice extends between an inner face of the radial wall and an outer surface of the radial wall.

Moreover, according to further embodiments, the exhaust additive dosing unit 6 may be configured to supply exhaust additive to the stream of exhaust gas inside the turbine outlet duct 3 in another manner than onto a distribution device 23. According to the embodiments illustrated in FIG. 3, the exhaust additive dosing unit 6 is arranged to supply the exhaust additive 20 to the stream of exhaust gas inside the turbine outlet duct 3 at a position located adjacent to the first end portion 15 of the turbine outlet duct 3. In this manner, it can be ensured that the exhaust additive 20 and the exhaust gas are mixed to a great extent before the mixture is reaching a Selective Catalytic Reduction SCR catalyst 45 of the combustion engine 40.

According to the embodiments illustrated in FIG. 3, the inlet opening 12, 12′ of the bypass channel 11 is arranged on the turbine housing 51, namely on the turbine inlet 24 of the turbine housing 51. That is, in more detail, according to the embodiments illustrated in FIG. 3, the inlet opening 12, 12′ of the bypass channel 11 is arranged on the turbine inlet scroll 52, 52′. As mentioned, according to the illustrated embodiments, the turbine inlet 24 comprises two turbine inlet scrolls 52, 52′ and according to the illustrated embodiments, the bypass channel 11 comprises two inlet openings 12, 12′ each arranged on one of the two turbine inlet scrolls 52, 52′.

The bypass channel 11 comprises a junction 11′ which fluidly connects the two inlet openings 12, 12′. Obviously, according to the illustrated embodiments, the bypass channel 11 comprises a respective bypass path between the junction 11′ and the respective inlet opening 12, 12′. The junction 11′ is arranged upstream of the NOx sensor 9 as seen along an intended flow direction through the bypass channel 11. The intended flow direction through the bypass channel 11 extends from the inlet opening/openings 12, 12′ towards the outlet opening 22 of the bypass channel 11.

According to the illustrated embodiments, the outlet opening 22 of the bypass channel 11 is arranged on the turbine housing 51. In more detail, according to the illustrated embodiments, the turbine housing 51 comprises a waste gate chamber 7. The wastegate chamber 7 is configured to receive exhaust gas from a waste gate valve of a turbo device 30 comprising the turbine arrangement 1. As seen in FIG. 3, according to the illustrated embodiments, the outlet opening 22 is provided in a delimiting wall 7′ of the waste gate chamber 7. However, according to further embodiments, the outlet opening 22 may be arranged at a different portion of the exhaust system 50 downstream of the turbine outlet 29 of the turbine unit 19.

Moreover, according to the illustrated embodiments, the bypass channel 11 comprises a flow restriction portion 57. The flow restriction portion 57 has a smaller effective cross-sectional area than other portions of the bypass channel 11. The flow restriction portion 57 is arranged in the bypass channel 11 at a position upstream of the NOx sensor 9 as seen relative to the intended flow direction through the bypass channel 11. Due to the flow restriction portion 57, damages to the NOx sensor 9 caused by excessive temperatures and/or pressures is further avoided in an efficient manner. Moreover, it can be ensured that the NOx sensor 9 can provide reliable data over the full operational range of the internal combustion engine 40 comprising the exhaust system 50.

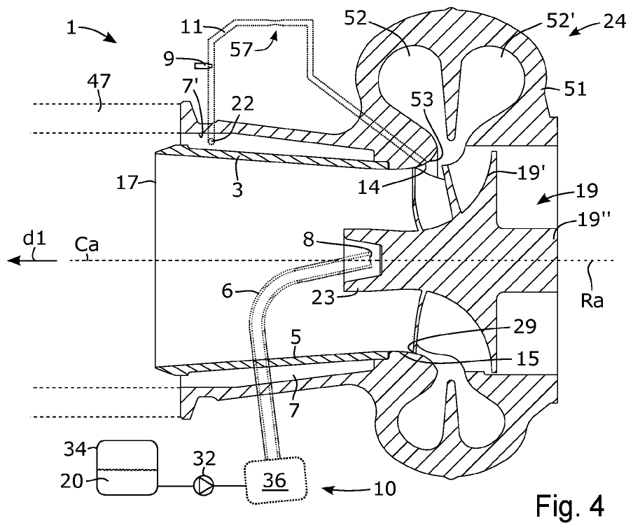

FIG. 4 illustrates a cross section of a turbine arrangement 1 according to some further embodiments. The exhaust system 50 of the internal combustion engine 40 illustrated in FIG. 2 may comprise a turbine arrangement 1 according to the embodiments illustrated in FIG. 4. Therefore, below, simultaneous reference is made to FIG. 2 and FIG. 4, if not indicated otherwise. The turbine arrangement 1 illustrated in FIG. 4 comprises the same features, functions, and advantages as the turbine arrangement 1 illustrated in FIG. 3, with some exceptions explained below.

Also in the embodiments illustrated in FIG. 4, the inlet opening 14 of the bypass channel 11 is arranged on the turbine inlet 24 of the turbine housing 51. However, according to the embodiments illustrated in FIG. 4, the inlet opening 14 of the bypass channel 11 is arranged on the turbine shroud 53. As mentioned, the turbine shroud 53 encloses at least a portion of the turbine 19′ of the turbine unit 19.

Since the inlet opening 14 of the bypass channel 11 is arranged on the turbine shroud 53, it can be ensured that exhaust gases from different cylinders of the combustion engine 40 are mixed before flowing into the bypass channel 11 via the inlet opening 14. In this manner, conditions are provided for obtaining even more reliable data of the NOx content of the exhaust gas flowing through the turbine unit 19 of the turbine arrangement 1. Moreover, a space efficient solution is provided requiring only a short routing of the bypass channel 11. Furthermore, damages to the NOx sensor 9 caused by excessive temperatures and/or pressures can be further avoided due to lower temperatures and pressures of the exhaust gas in the turbine shroud 53 as compared to exhaust gas in portions of the exhaust system 50 further upstream.

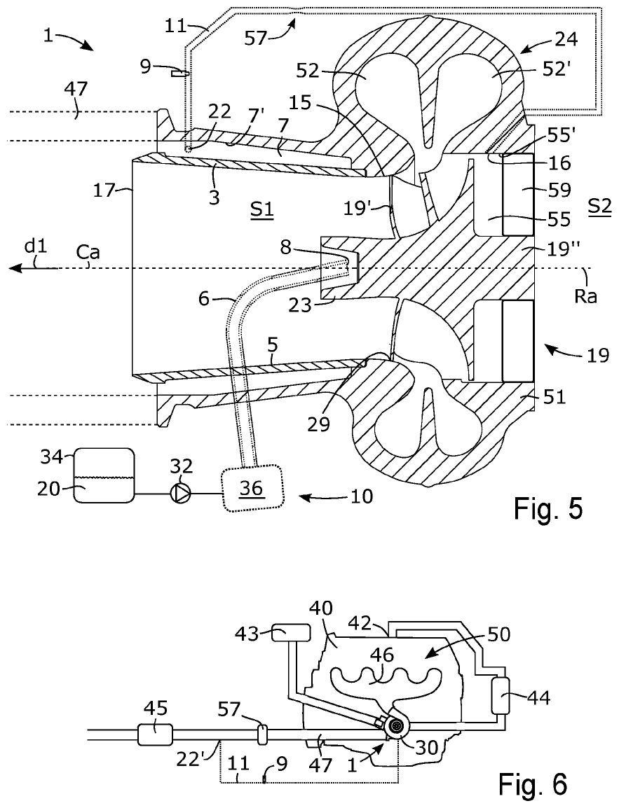

FIG. 5 illustrates a cross section of a turbine arrangement 1 according to some further embodiments. The exhaust system 50 of the internal combustion engine 40 illustrated in FIG. 2 may comprise a turbine arrangement 1 according to the embodiments illustrated in FIG. 5. Therefore, below, simultaneous reference is made to FIG. 2 and FIG. 5, if not indicated otherwise. The turbine arrangement 1 illustrated in FIG. 5 comprises the same features, functions, and advantages as the turbine arrangement 1 illustrated in FIG. 3, with some exceptions explained below.

As is indicated in FIG. 5, the turbine outlet duct 3 is configured to receive exhaust gas from the turbine outlet 29 at a first side S1 of the turbine 19′ of the turbine unit 19. Moreover, the turbine housing 51 comprises a compartment 55 at a second side S2 of the turbine 19′ of the turbine unit 19. The second side S2 of the turbine 19′ of the turbine unit 19 is opposite to the first side S1 of the turbine 19′ of the turbine unit 19. According to the embodiments illustrated in FIG. 5, the inlet opening 16 of the bypass channel 11 is fluidly connected to the compartment 55 at the second side S2 of the turbine 19′ of the turbine unit 19.

In more detail, according to the embodiments illustrated in FIG. 5, the inlet opening 16 of the bypass channel 11 is provided in a delimiting wall 55′ of the compartment 55. According to the illustrated embodiments, the delimiting wall 55′ of the compartment 55 is a wall of the turbine housing 51. The compartment 55 is delimited by the delimiting wall 55′, a backside of the turbine 19′ of the turbine unit 19, the shaft 19″ of the turbine unit 19, and by a sealing assembly 59. The sealing assembly 59 may comprise one or more sealings, heat shields, and the like.

Since the inlet opening 16 of the bypass channel 11 is fluidly connected to the compartment 55 at the second side S2 of the turbine 19′ of the turbine unit 19, it can be ensured that exhaust gases from different cylinders of the combustion engine 40 are mixed before flowing into the bypass channel 11 via the inlet opening 16. In this manner, conditions are provided for obtaining even more reliable data of the NOx content of the exhaust gas flowing through the turbine unit 19 of the turbine arrangement 1. Moreover, a space efficient solution is provided requiring only a short routing of the bypass channel 11. Furthermore, damages to the NOx sensor 9 caused by excessive temperatures and/or pressures can be further avoided due to lower temperatures and pressures of the compartment 55 at the second side S2 of the turbine 19′ as compared to exhaust gas in portions of the exhaust system 50 further upstream.

In the embodiments illustrated in FIG. 4 and FIG. 5, the outlet opening 22 of the bypass channel 11 is provided in the delimiting wall 7′ of the waste gate chamber 7. However, also in these embodiments, the outlet opening 22 may be arranged at a different portion of the exhaust system 50 downstream of the turbine outlet 29 of the turbine unit 19.

FIG. 6 illustrates an exhaust system 50 according to some further embodiments. The exhaust system 50 illustrated in FIG. 6 may comprise the same features, functions, and advantages as the exhaust system 50 explained with reference to FIG. 2-FIG. 5, with some exceptions explained below. FIG. 6 also illustrates an internal combustion engine 40 which comprises the exhaust system 50. The vehicle 2 illustrated in FIG. 1 may comprise an internal combustion engine 40 according to the embodiments illustrated in FIG. 6.

According to the embodiments illustrated in FIG. 6, the exhaust system 50 comprises an exhaust throttle 57. The exhaust throttle 57 is controllable to a closed state in which the exhaust throttle 57 at least partially blocks flow of exhaust gas past the exhaust throttle 57. The closed state, as referred to herein, may thus also be referred to as “an at least partially closed state”, or simply “a state in which the exhaust throttle 57 at least partially blocks flow of exhaust gas past the exhaust throttle 57”. Due to the exhaust throttle 57, the combustion engine 40 can be braked in an efficient manner by providing an opposing force on pistons of the combustion engine 40 during the exhaust strokes thereof.

In FIG. 6, the bypass channel 11 of the exhaust system 50 is schematically indicated. The bypass channel 11 may comprise an inlet opening having a position corresponding to the position of the inlet opening/openings 12, 12′, 14, 16 in any one of the embodiments explained with reference to FIG. 3-FIG. 5. As can be seen in FIG. 6, in these embodiments, the outlet opening 22′ of the bypass channel 11 is arranged downstream of the exhaust throttle 57. Thereby, the NOx sensor 9 is protected from becoming damaged by excessive pressures when the exhaust throttle 57 is controlled to the closed state.

The wording “adjacent to”, as used herein, may encompass that the objects referred to is within 1-2 centimetres from each other.

The wording upstream and downstream, as used herein, relates to the relative positions of objects in relation to an intended flow direction of fluid in the system referred to. As an example, the feature that a first object is arranged upstream of a second object in a system means that the first object is arranged before the second object seen relative to the intended flow direction of fluid through the system. As another example, the feature that a first object is arranged downstream of a second object in a system means that the first object is arranged after the second object seen relative to the intended flow direction of fluid through the system.

Accordingly, the feature that the bypass channel 11 comprises an inlet opening 12, 12′, 14, 16 arranged upstream of a turbine outlet 29 of the turbine unit 19 means that the inlet opening 12, 12′, 14, 16 is arranged in the exhaust system 50 at a position upstream of the turbine outlet 29 of the turbine unit 19 as seen relative to the intended flow direction of exhaust gas through the exhaust system 50. Likewise, the feature that the bypass channel 11 comprises an outlet opening 22, 22′ arranged downstream of the turbine outlet 29 means that the outlet opening 22, 22′ is arranged downstream of the turbine outlet 29 as seen relative to the intended flow direction of exhaust gas through the exhaust system 50.

It is to be understood that the foregoing is illustrative of various example embodiments and that the invention is defined only by the appended independent claims. A person skilled in the art will realize that the example embodiments may be modified, and that different features of the example embodiments may be combined to create embodiments other than those described herein, without departing from the scope of the present invention, as defined by the appended independent claims.

As used herein, the term “comprising” or “comprises” is open-ended, and includes one or more stated features, elements, steps, components, or functions but does not preclude the presence or addition of one or more other features, elements, steps, components, functions, or groups thereof.

1. An exhaust system for an internal combustion engine, wherein the exhaust system comprises a turbine arrangement for a turbo device,
the turbine arrangement comprising a turbine housing and a turbine unit arranged to rotate in the turbine housing,
and wherein the exhaust system (50) comprises a bypass channel with an inlet opening arranged upstream of a turbine outlet of the turbine unit and an outlet opening arranged downstream of the turbine outlet,
and wherein the exhaust system comprises a NOx sensor configured to sense a NOx content of exhaust gas flowing through the bypass channel.

2. The exhaust system according to claim 1, wherein the inlet opening of the bypass channel is arranged on the turbine housing.

3. The exhaust system according to claim 1, wherein the turbine housing comprises a turbine inlet, and wherein the inlet opening of the bypass channel is arranged on the turbine inlet of the turbine housing.

4. The exhaust system according to claim 3, wherein the turbine inlet comprises a turbine inlet scroll, and wherein the inlet opening of the bypass channel is arranged on the turbine inlet scroll.

5. The exhaust system according to claim 3, wherein the turbine inlet comprises two turbine inlet scrolls and wherein the bypass channel comprises two inlet openings each arranged on one of the two turbine inlet scrolls.

6. The exhaust system according to claim 1, wherein the turbine housing comprises a turbine shroud enclosing at least a portion of the turbine unit, and wherein the inlet opening of the bypass channel is arranged on the turbine shroud.

7. The exhaust system according to claim 1, wherein the turbine arrangement comprises a turbine outlet duct configured to receive exhaust gas from the turbine outlet at a first side of the turbine unit, wherein the turbine housing comprises a compartment at a second side of the turbine unit being opposite to the first side, and wherein the inlet opening of the bypass channel is fluidly connected to the compartment.

8. The exhaust system according to claim 1, wherein the bypass channel comprises a flow restriction portion having a smaller effective cross-sectional area than other portions of the bypass channel, and wherein the flow restriction portion is arranged in the bypass channel at a position upstream of the NOx sensor.

9. The exhaust system according to claim 1, wherein the turbine housing comprises a turbine outlet duct configured to receive exhaust gas from the turbine outlet, and wherein the turbine arrangement comprises an exhaust additive dosing unit arranged to supply an exhaust additive inside the turbine outlet duct.

10. The exhaust system according to claim 9, wherein the turbine arrangement comprises a distribution device arranged on the turbine unit, and wherein the exhaust additive dosing unit is arranged to supply an exhaust additive onto the distribution device.

11. The exhaust system according to claim 1, wherein the outlet opening of the bypass channel is arranged on the turbine housing.

12. The exhaust system according to claim 1, wherein the turbine housing comprises a waste gate chamber configured to receive exhaust gas from a waste gate valve, and wherein the outlet opening is provided in a delimiting wall of the waste gate chamber.

13. The exhaust system according to claim 1, wherein the exhaust system comprises an exhaust throttle controllable to a closed state in which the exhaust throttle at least partially blocks flow of exhaust gas past the exhaust throttle, and wherein the outlet opening of the bypass channel is arranged downstream of the exhaust throttle.

14. An internal combustion engine comprising an exhaust system according claim 1.

15. A vehicle comprising an internal combustion engine according to claim 14.
